(19) United States
(12) Patent Application Publication
(10) Pub. No.: US 2014/0328334 A1
(43) Pub. Date: Nov. 6, 2014

(54) PROVISIONING A WIRELESS DEVICE FOR SECURE COMMUNICATION USING AN ACCESS POINT DESIGNED WITH PUSH-BUTTON MODE OF WPS (WI-FI PROTECTED SETUP)

(71) Applicant: GAINSPAN CORPORATION, San Jose, CA (US)

(72) Inventors: PRASHANT VISWANATHAN, Bangalore (IN); Vishal Batra, Bangalore (IN); Pankaj Vyas, Bangalore (IN)

(73) Assignee: GainSpan Corporation, San Jose, CA (US)

(21) Appl. No.: 13/886,276

(22) Filed: May 3, 2013

(51) Int. Cl. H04W 76/02; H04W 12/06

(52) U.S. Cl. CPC H04W 76/021; H04W 12/06
USPC 370/338

(57) ABSTRACT

A wireless device is provisioned according to WPS (WiFi Protected Setup) push button mode. The wireless device receives an electronic signal from a provisioning agent external to the wireless device, the electronic signal indicating to the wireless device that the wireless device is to start WPS provisioning procedures. A user presses a push button on an AP to which the wireless device is to be connected. On receipt of the electronic signal, the wireless device enrolls in a wireless network, of which the AP is a part, by communicating with the access point in accordance with push button mode of WPS. The technique enables a wireless device to be provisioned without a user requiring to press any button on the wireless device.

### BACKGROUND OF THE INVENTION

1. Technical Field

Embodiments of the present disclosure relate generally to wireless networks, and more specifically to provisioning a wireless device for secure communication using an access point designed with push-button mode of WPS (Wi-Fi Protected Setup).

2. Related Art

An access point (AP) refers to a switching device, which receives packets from one wireless device and forwards the packet to or towards a target device. The target device is often another wireless device in the same wireless network, though it can be a device connected through a wired network via the access point. The access point communicates with the wireless devices using protocols such as WLAN operating according to IEEE 802.11 standard.

There is a general need to implement secure communication between wireless devices and APs, or between wireless device and other systems on a wired network via an AP. Secure communication implies features such as preventing malicious or unintended wireless devices from communicating via an AP, and also ensuring that third parties cannot decipher the packet content by snooping on the wireless medium.

A wireless device generally needs to be provisioned before being able to communicate with other devices via an AP implementing various security measures. Provisioning generally entails configuring (e.g., storing at appropriate locations) the wireless device with various parameters that enable the wireless device to comply with the security measures enforced by the AP. In many WLAN environments the parameters include SSID (Service set identification) of the network and a passphrase, as is well known in the relevant arts.

WPS (Wi-Fi Protected Setup) is a standard that has been adopted by many vendors of APs and wireless devices, to simplify configuration of a new wireless device in a wireless network at locations such as homes. A push-button mode is one of the approaches defined by WPS, in which a user is normally required to press respective buttons of an AP and a new wireless device (enrollee) within a short duration (typically 2 minutes) such that the AP (or other device operating as a registrar) can automatically provide the configuration information/parameters to the wireless device.

There are at least some situations in which it may be desirable to provision wireless devices without having to use a push button (on the wireless device). For example, the wireless device may be in locations that are not easily accessible, or it may be undesirable to provide push buttons on a wireless device (e.g., in headless devices, which normally have at best minimal user interface physical elements). However, it may be convenient to use push-button mode of WPS for provisioning such wireless devices as well.

### BRIEF DESCRIPTION OF THE VIEWS OF DRAWINGS

Example embodiments of the present invention will be described with reference to the accompanying drawings briefly described below.

FIG. 1 is a block diagram representing an example environment in which several aspects of the present disclosure can be implemented.

FIG. 2 is a flowchart illustrating the manner in which a wireless device is provisioned according to WPS push button mode, in an embodiment.

FIG. 3 is a diagram illustrating the sequence of messages exchanged between respective devices in provisioning a wireless device, in an embodiment.

FIG. 4 is a diagram showing a portion of a message broadcast by a wireless device requesting to be provisioned, in an embodiment.

FIG. 5 is a diagram showing a portion of a message transmitted by a provisioning agent to a wireless device which has requested to be provisioned, in an embodiment.

FIG. 6 is a block diagram illustrating the internal blocks of a wireless device, in an embodiment.

FIG. 7 is a block diagram illustrating the details of a wireless device in an embodiment in which various aspects of the present invention are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

1. Overview

According to an aspect of the present disclosure, a wireless device receives an electronic signal from a provisioning agent external to the wireless device. The electronic signal indicates to the wireless device that the wireless device is to start WPS provisioning procedures. A user presses a push button on an AP to which the wireless device is to be connected. On receipt of the electronic signal, the wireless device enrolls in a wireless network, of which the AP is a part, by communicating with the access point in accordance with push button mode of WPS. The technique enables a wireless device to be provisioned without a user requiring to press any button (if at all, such a button exists) on the wireless device.

Several aspects of the invention are described below with reference to examples for illustration. It should be understood that numerous specific details, relationships, and methods are set forth to provide a full understanding of the invention. One skilled in the relevant arts, however, will readily recognize that the invention can be practiced without one or more of the specific details, or with other methods, etc. In other instances, well-known structures or operations are not shown in detail to avoid obscuring the features of the invention.

2. Example Environment

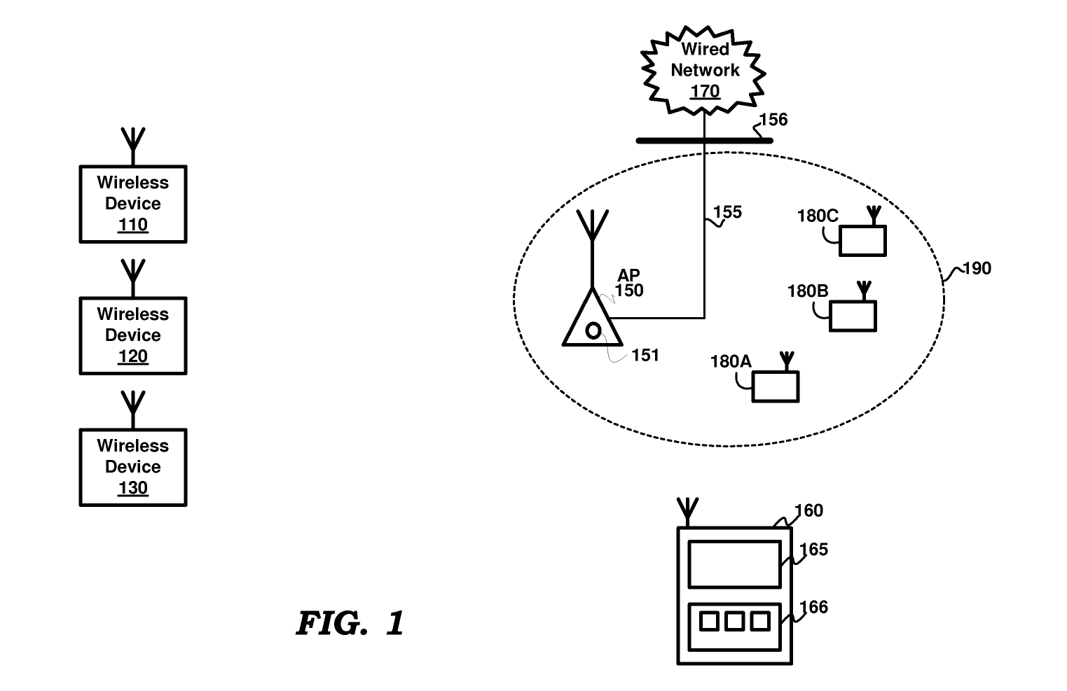

FIG. 1 is a block diagram representing an example environment in which several aspects of the present disclosure can be implemented. The example environment is shown containing only representative systems for illustration. However, real world environments may contain more or fewer systems. FIG. 1 is shown containing wireless devices 110, 120 and 130, access point (AP) 150, WLAN wireless stations (or clients) 180A-180C, wired network backbone 156, wired network 170, and provisioning agent 160. Block 190 represents a basic service set (BSS) consistent with the IEEE 802.11 standard(s). Other environments may include more than one BSS, with the BSSs being interconnected to form an extended service set (ESS) consistent with IEEE 802.11 standards.

Each of clients 180A-180C is designed to operate as wireless stations consistent with IEEE 802.11 family of standards (including IEEE 802.11a, 802.11b, 802.11g and 802.11n), and may communicate, via AP 150, with each other as well as with devices/systems on wired network 170. It is assumed that clients 180A-180C are already provisioned to communicate securely via AP 150. Clients 180A-180C may correspond, for example, to laptop computers, smart phones, or wireless sensors.

AP 150 represents a switch/hub operating according to IEEE 802.11 family of standards, and enables associated wireless stations (e.g., 180A-180C) to communicate with each other as well as with systems connected to wired network 170. AP 150 is connected by a wired medium (155) to wired network backbone 156, and thus to wired network 170. Wired network 170 may represent the internet, also known as the World Wide Web. AP 150 is shown containing push button 151, which may be used when provisioning wireless devices according to the WPS push button mode, as described below.

Wireless devices 110, 120 and 130 represent devices that are capable of communicating wirelessly according to IEEE 802.11 (WLAN) standards, and can selectively operate as an AP or as a wireless station (client). According to an aspect of the present invention described below, wireless devices 110, 120 and 130 power-up as APs, and after completion of provisioning (described below) operate as wireless stations.

Each of wireless devices may have a core functionality (e.g., operation as a smart meter, sensor, etc), and the wireless communication capability according to IEEE 802.11 can be used to communicate various data and control parameters of interest with other devices via an AP (for example, AP 150). However, before the wireless devices 110, 120 and 130 can perform such communication, the wireless devices 110, 120 and 130 may need to be provisioned. As noted above, provisioning generally entails configuring the wireless devices with various parameters that enable the wireless devices to comply with the security measures enforced by an AP, in addition to specifying the particular AP with which to associate and thereafter communicate with other devices. The configuration parameters include SSID (Service Set Identification) of the network and a passphrase, as is well known in the relevant arts.

WPS push button mode is one approach according to which wireless devices 110, 120 and 130 can be provisioned. According to the WPS push button mode, a user presses corresponding push buttons on an AP and the wireless device to be provisioned. Thus, for example assuming wireless device 110 is required to associate with AP 150 and be provisioned by AP 150, a user would need to press push button 151 and a corresponding push button on wireless device 110. However, wireless device 110 (and devices 120 and 130 as well) may either be headless devices (not having, or having minimal user interface such that a push button for WPS is not available), or be located such that access to a WPS push button is difficult even when such a push button is provided.

Provisioning agent 160 represents an agent external to each of devices 110, 120 and 130 and also access point 150. As may be readily observed, each of the devices 110/120/130, access point 150 and provisioning agent 160 are implemented as respective separate units. In an embodiment, provisioning agent 160 corresponds to a mobile phone containing display 165 and keyboard 166. Provisioning agent 160 enables wireless devices 110, 120 and 130 to be provisioned according to the WPS push button mode even when no push button is provided on the devices, or when the devices are difficult to access physically. Provisioning agent 160 may contain the necessary application software needed to enable provisioning of wireless devices 110, 120 and 130.

The manner in which a wireless device is provisioned according to WPS push button mode is illustrated next with respect to a flowchart.

3. Provisioning According to WPS Push Button Mode

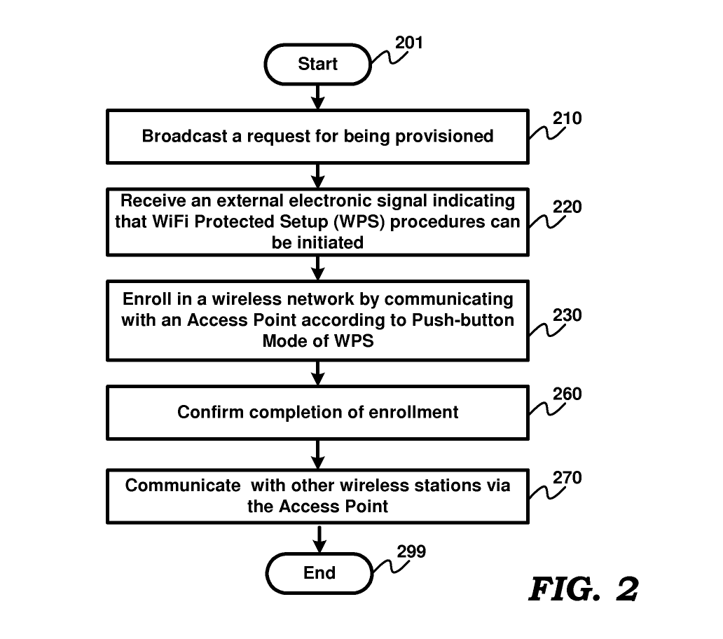

FIG. 2 is a flowchart illustrating the manner in which a wireless device is provisioned according to WPS push button mode, in an embodiment. The flowchart is described with respect to the environment of FIG. 1 and wireless device 110, merely for illustration. However, various features described herein can be implemented in other environments and using other components as well, as will be apparent to one skilled in the relevant arts by reading the disclosure provided herein. Further, the steps in the flowchart are described in a specific sequence merely for illustration. Alternative embodiments using a different sequence of steps can also be implemented without departing from the scope and spirit of several aspects of the present invention, as will be apparent to one skilled in the relevant arts by reading the disclosure provided herein. The flowchart starts in step 201, in which control passes immediately to step 210.

In step 210, wireless device 110 broadcasts a request for being provisioned. Provisioning agent 160 may be implemented to recognize such requests upon receipt. In general, any convention can be used for such requests and provisioning agent 160 needs to be within the transmission range of wireless device 110 to receive the request and thereafter recognize the provisioning request. In an embodiment, the request is in the form of a beacon according to IEEE 802.11 standards, with the SSID field set to a pre-specified message such as ‘Wireless Device 110—Need provisioning’, with the text “Wireless Device 110′ representing the name of the device and the text ‘Need provisioning’ specifying that the packet represents the provisioning request. Beacon frame formats are described in section 7.2.3.1 “Beacon frame format” of IEEE Std 802.11™-2007 available from IEEE.

In step 220, wireless device 110 receives an external electronic signal indicating that WiFi Protected Setup (WPS) procedures can be initiated. The word external implies that the electronic signal originates from external to the wireless device (contrasted with internal signals that originate internal to the wireless device). In the example scenario of FIG. 1, the electronic signal originates from provisioning agent 160. Thus, provisioning agent 160 may be provided with a suitable interface (e.g., display 165) to indicate that wireless device 110 has requested provisioning and a user may manually initiate the issuance of the electronic signal using a convenient user interface. The user presses push button 151 of access point 150 (which is to operate as a registrar for wireless device 110), and thereafter initiates issuance of the electronic signal by operating provisioning agent 160. Thus, the external electronic signal generally indicates that there is an access point ready to enroll the wireless device 110.

In step 230, wireless device 110 enrolls in a wireless network by communicating with access Point 150 according to Push-button Mode of WPS. Such enrollment may be performed in a known way. Due to such enrollment, wireless device 110 may be automatically (i.e., without requiring further manual effort) configured with parameters required for communication via AP 150 (or in general the BSS of which AP 150 is a part). In an embodiment, such parameters include SSID and a passphrase, used for secure communications, as described above.

In step 260, wireless device 110 confirms completion of enrollment to provisioning agent 160, and the user may be again notified of successful completion of provisioning. In step 270, wireless device 110 is able to communicate via access point 150 to other wireless stations (e.g., clients 180A, 180B, 180C), etc., in view of completion of provisioning. The flow chart ends in step 299. The operations of the flowchart described above may be repeated to sequentially (one after the other) provision wireless devices 120 and 130 as well, with provisioning agent 160 transmitting corresponding external electronic signals (similar to as in step 220) to wireless devices 120 and 130, with the user also pressing push button 151 of access point 150 for each corresponding provisioning.

The confirmation of completion of enrollment of step 260 may be indicated after wireless device 110 starts operation in secure mode (as a part of BSS 190). Wireless device 110 sends the confirmation of step 260 to provisioning agent 160 via AP 150 in the usual manner in which a pair of wireless stations of a WLAN infrastructure network communicates via a corresponding AP. Wireless device 110 may send the confirmation of completion either as a broadcast or a unicast signal. When the message is a broadcast signal, AP 150 forwards the message to all stations in BSS 190, and thus the message reaches provisioning agent 160.

When the confirmation message is a unicast message, wireless device 110 may use the IP address of provisioning agent 160 for such a purpose. Provisioning agent 160 and its IP address can be discovered using protocols such as mDNS/DNS-SD or UPnP. ARP type protocols may be used to resolve the MAC address of the provisioning agent 160 based on the IP address, before sending of the unicast message to confirm completion of the enrollment.

Wireless device 110 may similarly indicate to provisioning agent 160 if the provisioning is unsuccessful. Such notification may be provided by appropriate text in SSID field of a beacon message, similar to as in the message of step 210.

Thus, it may be appreciated that the external electronic signal from provisioning agent 160 operates as the equivalent of a push button in wireless device 110. As a result, headless devices and also wireless devices which are in difficult-to-access locations may be provisioned conveniently using push button mode of WPS. The description is continued with respect to example messages that are exchanged in an embodiment.

4. Messages

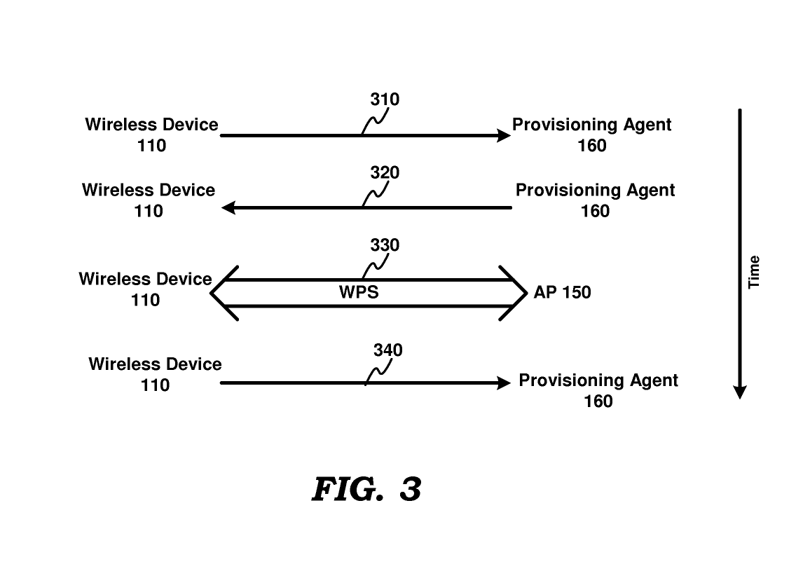

FIG. 3 is a diagram illustrating the sequence of messages exchanged (in an embodiment) between respective devices in provisioning wireless device 110 as described above with respect to flowchart of FIG. 2. Wireless device 110 broadcasts message 310 to provisioning agent 160, with message 310 being a request to be provisioned (step 210). Provisioning agent 160 then transmits message 320 to wireless device 110, with message 320 representing a command to start WPS push button mode provisioning procedures (step 220). A user may then press push button 151 on AP 150. The pressing of push button 151 can instead be done before the transmission of message 320 also. However, it is noted that WPS procedures should be initiated within two minutes of the pressing of button 151. Hence, the sending of message 320 should happen such that messages 330 are exchanged within two minutes of pressing of button 151.

Subsequently, wireless device 110 and AP 150 exchange a sequence of eight messages M1-M8 (noted as 330 in FIG. 3) to perform WPS provisioning to cause wireless device 110 to be enrolled with AP 150 (step 230). The specific details of the messages M1-M8, as well as additional details of WPS, are described further in Wi-Fi Protected Setup Specification, Version 1.0h, December 2006, published by the WiFi™ Alliance, which is incorporated in its entirety herewith.

During the exchange of messages M1-M8, AP 150 provides to wireless device 110 the SSID of the network (BSS 190) as well as the passphrase from which to derive encryption/decryption keys for encrypting/decrypting subsequent communication between wireless device 110 and AP 150. With provisioning being complete, wireless device 110 becomes a part of BSS 190 (although not indicated as such in FIG. 1), and may commence communication with other devices in BSS 190 and/or external devices.

Once wireless device 110 becomes a part of BSS 190, wireless device 110 and provisioning agent 160 can communicate with each other using high level protocols (above layer 2). Further, subsequent to becoming a part of BSS 190, wireless device 110 transmits message 340 to provisioning agent 160 indicating that provisioning according to WPS push button mode is complete. Message 340 may be designed according to one of several known ways.

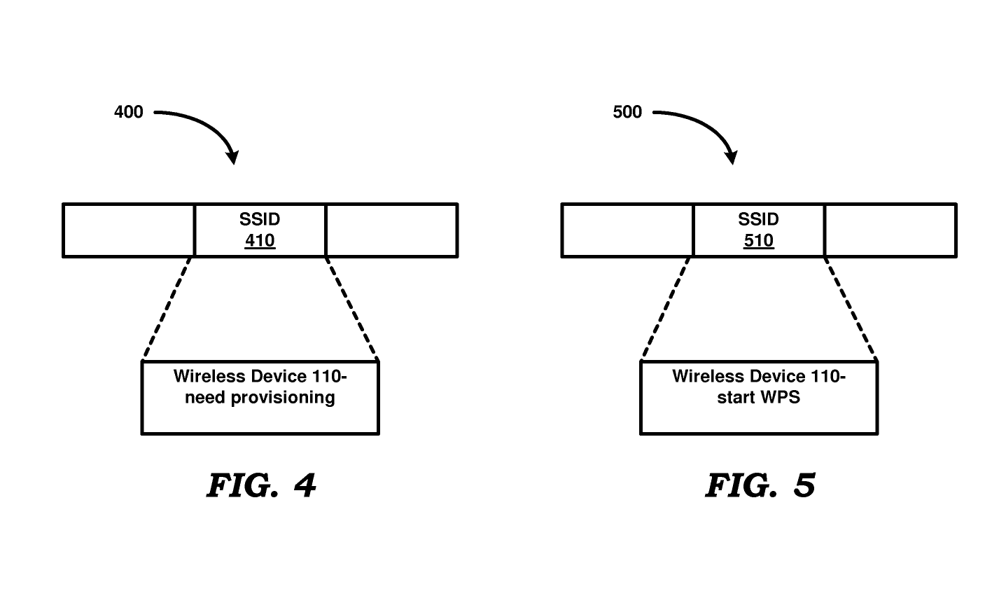

In an embodiment, a not-yet-provisioned device such as wireless device 110 powers-up as an access point (AP), and message 310 is a beacon frame as defined by the WLAN standard. FIG. 4 is a diagram depicting a portion of a beacon frame 400 broadcast by wireless device 110. Field 410 represents the field that would normally contain the SSID (identifier of a wireless network), but is instead used for requesting provisioning agent 160 that wireless device 110 be provisioned. In the example request of FIG. 4, field 410 is shown as containing the text “Wireless Device 110—need provisioning”, which specifies that wireless device 110 is requesting for being provisioned.

Provisioning agent 160, operating as a wireless station (client) according to WLAN specification, may be commanded by a user to scan the various frequency bands allotted for WLAN operation for signals/transmissions from other wireless devices. During the scan, provisioning agent 160 receives beacon 400 from wireless device 110. Provisioning agent 160 parses the SSID field (410) and determines that wireless device 110 is requesting for provisioning. Beacon 400 corresponds to message 310 of FIG. 3.

In response to receipt of beacon 400, provisioning agent 160 transmits to wireless device 110 a probe request frame 500 according to the WLAN standard. Probe request frame format is described in detail in section 7.2.3.8 “Probe Request frame format” of IEEE Std 802.11™-2007 available from IEEE. Prior to transmission of frame 500, provisioning agent 160 enters the text “Wireless Device 110—start WPS” in the SSID field 510 of probe request frame 500, as shown in FIG. 5. The receipt of message 400 may occur during a scan performed by provisioning agent 160. Probe request 500 is a broadcast message. Upon receipt of message 500, wireless device 110 interprets the contents of SSID field 510 as a command from provisioning agent 160 to start WPS procedures as noted above.

In an embodiment, provisioning agent 160 scans the WLAN channels to compile a list of all wireless devices (such as devices 110, 120 and 130) seeking provisioning in the manner described above. Provisioning agent 160 then presents the list to a user (e.g., on display screen 165), the user then selecting (via keyboard 166) the specific ones of the wireless devices that the user wishes to be provisioned. Subsequently, provisioning agent 160 sequentially commands the user-selected wireless devices to initiate WPS push button mode, the user also activating WPS on the side of AP 150 by pressing push button 151 each time. Each of the user-selected devices also sends a confirmation message (step 260) to provisioning agent 160 once provisioning of that device is complete, the confirmation message enabling provisioning agent 160 to signal a next one of the user-selected devices to initiate WPS (after again pressing the push button on AP 150).

Thus, one or more wireless devices can be conveniently provisioned. The description is continued with respect to an illustration of the internal blocks of wireless device 110 in an embodiment.

5. Wireless Device

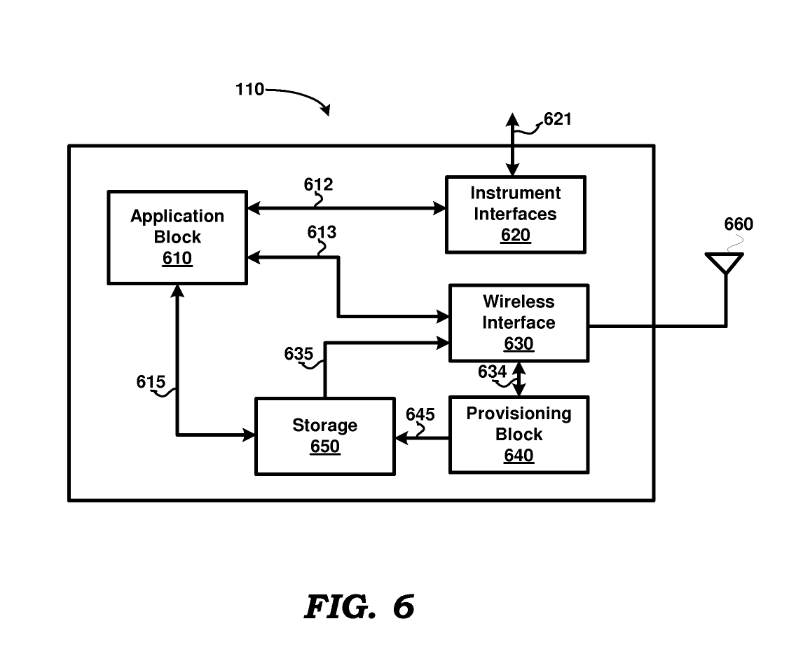

FIG. 6 is a block diagram illustrating the internal blocks of wireless device 110, in an embodiment. Wireless device 110 is shown containing application block 610, instrument interfaces 620, wireless interface 630, antenna 660, provisioning block 640 and storage 650.

Instrument interfaces 620 represent interfaces to sensors, actuators, or other devices which may be connected (via path 621) to wireless device 110 to enable wireless device 110 to provide the core functionality noted above.

Application block 610 represents one or more applications that execute in wireless device 110 to provide desired features. For example, applications 610 may represent data collection or control applications such as those required in industrial control systems. Applications in application block 610 may operate on data received from external sensors via instrument interfaces 620 on path 612, as well as provide outputs on path 612 to external actuators via instrument interfaces 620. Applications in application block 610 may communicate with other systems/devices via wireless interface 630 and path 613.

Wireless interface 630 represents the combination of hardware, software and firmware components that enable wireless device 110 to communicate wirelessly (via antenna 680) according to IEEE 802.11 standards. It may be observed that the communications of steps 210 and 220 are via wireless interface 630, since provisioning agent 160 is external to wireless device 110, and communication is by wireless medium. Storage 650 contains both volatile (random access) and non-volatile hardware components. The non-volatile component may be used for storing the security credentials when obtained from provisioning wireless device 110 in accordance with the flowchart of FIG. 2.

Provisioning block 640 operates to enable provisioning of wireless device 110 according to various aspects of the present invention as described in detail above. Thus, provisioning block 640 may (in conjunction with wireless interface 630) perform steps 210, 220, 230 and 260 of the flowchart of FIG. 2. Provisioning block 640 may store (via path 645) in storage 650, the SSID and secure credentials (obtained during provisioning) for joining BSS 190 and communicating with/via AP 150 thereafter. For subsequent operations, wireless interface 630 may directly fetch the stored credentials and SSID from storage 650 via path 635. Applications in application block 610 may also use the non-volatile portion of storage 650 for storing of data via path 615.

It should be appreciated that the blocks of FIG. 6 can be enabled with the features described above as a desired combination of one or more of hardware, executable modules, and firmware. The description is continued with respect to an example embodiment in which several features of the present invention are operative on execution of corresponding executable modules.

6. Digital Processing System

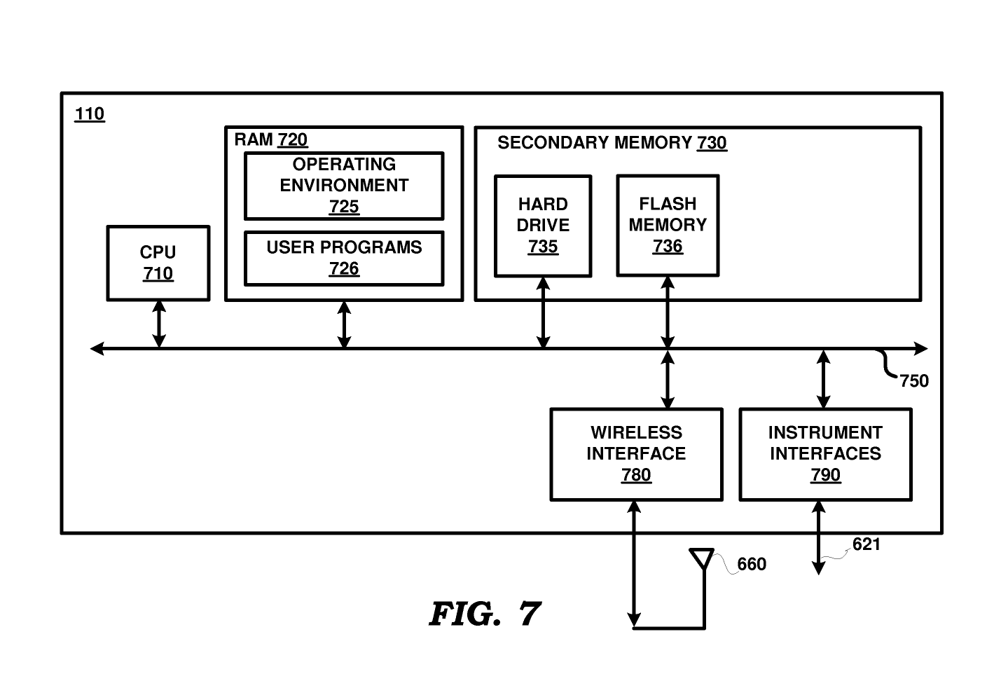

FIG. 7 is a block diagram illustrating the details of wireless device 110 in an embodiment in which various aspects of the present invention are operative by execution of appropriate executable modules. Wireless device 110 may contain one or more processors such as a central processing unit (CPU) 710, random access memory (RAM) 720, secondary memory 730, wireless interface 780 and instrument interfaces 790. All the components may communicate with each other over communication path 750, which may contain several buses as is well known in the relevant arts.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 (non-transitory/non-volatile machine readable storage medium) via communication path 750. RAM 720 is shown currently containing software instructions constituting operating environment 725 and/or other code/user programs 726. In addition to operating system 725, RAM 720 may contain other software programs such as device drivers, etc., which provide a (common) run time environment for execution of code/programs/applications (in the form of execution entities).

Secondary memory 730 is shown containing hard drive 735 and flash memory 736. Secondary memory 730 stores data and software instructions (code), which enable wireless device 110 to be provisioned in accordance with the present disclosure. In addition, secondary memory 730 may contain code to enable wireless device 110 to communicate with other devices, and provide user-level features as well. The software instructions (and additionally data) may either be copied to RAM 720 prior to execution by CPU 710, or may be executed directly from flash memory 736. Application block 610 and provisioning block 640 of FIG. 6 may be contained in the software instructions (code) stored in secondary memory 730.

Wireless interface 780 and instrument interfaces 790 correspond respectively to wireless interface 630 and instrument interfaces 620 of FIG. 6.

7. Conclusion

References throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A method of provisioning a wireless device for communication with an access point, said method comprising:
receiving an electronic signal from an agent; and
responsive to receipt of said electronic signal, enrolling in a wireless network by communicating with an access point in accordance with a push-button mode of WPS standard, wherein said wireless network comprises said access point,
wherein said agent is implemented external to both of said access point and said access point.

2. The method of claim 1, wherein said enrolling comprises:
receiving a set of parameters from said access point, wherein said set of parameters are required to securely communicate with said access point; and
configuring said wireless station with said set of parameters to enable said wireless device to join a basic service set (BSS) of which said access point is a member.

3. The method of claim 2, wherein said set of parameters comprise a SSID of said access point and a passphrase used in accordance with a security protocol.

4. The method of claim 2, further comprising:
broadcasting a request for being provisioned, wherein said electronic signal is received responsive to said broadcasting.

5. The method of claim 4, wherein said request is broadcast in the form of a beacon message.

6. The method of claim 2, further comprising communicating with other wireless stations of said wireless network upon completion of said enrolling.

7. The method of claim 1, wherein said electronic signal comprises a probe request message, wherein an SSID field of said probe request message contains a command to initiate provisioning according to said push-button mode of WPS standard.

8. The method of claim 2, further comprising:
sending a confirmation message from said wireless device to said provisioning agent, said confirmation message specifying whether said enrolling was successful or not.

9. A non-transitory machine readable storage medium storing one or more sequences of instructions for provisioning a wireless device for communication with an access point, wherein execution of said one or more sequences of instructions by one or more processors contained in said wireless device enables said wireless device to perform the actions of:
receiving an electronic signal from an agent; and
responsive to receipt of said electronic signal, enrolling in a wireless network by communicating with an access point in accordance with a push-button mode of WPS standard, wherein said wireless network comprises said access point,
wherein said agent is implemented external to both of said access point and said access point.

10. The non-transitory machine readable storage medium of claim 9, wherein said enrolling comprises:
receiving a set of parameters from said access point, wherein said set of parameters are required to securely communicate with said access point; and
configuring said wireless station with said set of parameters.
wherein said set of parameters comprise a SSID of said access point and a passphrase used in accordance with a security protocol.

11. The non-transitory machine readable storage medium of claim 9, further comprising instructions to enable said wireless device to perform the action of:
broadcasting a request for being provisioned, wherein said electronic signal is received responsive to said broadcasting.

12. The non-transitory machine readable storage medium of claim 11, wherein said request is broadcast in the form of a beacon message.

13. The non-transitory machine readable storage medium of claim 10, further comprising instructions to cause said wireless device to perform the action of communicating with other wireless stations of said wireless network upon completion of said enrolling.

14. The non-transitory machine readable storage medium of claim 9, wherein said electronic signal comprises a probe request message, wherein an SSID field of said probe request message contains a command to initiate provisioning according to said push-button mode of WPS standard.

15. A system comprising:
a provisioning agent to generate an electronic signal to command a wireless device to initiate push button mode of WPS; and
a wireless device designed to:
receive said electronic signal from said provisioning agent; and
enroll, in response to receipt of said electronic signal, in a wireless network by communicating with an access point in accordance with a push-button mode of WPS standard, wherein said wireless network comprises said access point.

16. The system of claim 15, wherein during said enrolling, said wireless device receives a set of parameters from said access point, wherein said set of parameters are required to securely communicate with said access point.

17. The system of claim 16, wherein said set of parameters comprise an SSID of said access point and a passphrase used in accordance with a security protocol.

18. The system of claim 17, wherein said wireless device broadcasts a request for being provisioned, wherein said provisioning agent generates said electronic signal in response to receipt of said request.

19. The system of claim 16, wherein said request is broadcast in the form of a beacon message, wherein said electronic signal comprises a probe request message, wherein an SSID field of said probe request message contains a command to initiate provisioning according to said push-button mode of WPS standard.

20. The system of claim 16, wherein said wireless device sends a confirmation message to said provisioning agent, said confirmation message specifying whether said enrolling was successful or not.
